(19) United States
(12) Patent Application Publication
(10) Pub. No.: US 2020/0087801 A1
(43) Pub. Date: Mar. 19, 2020

(54) HYDROGEN PROCESSING DEVICE

(71) Applicant: HONDA MOTOR CO., LTD., MINATO-KU, TOKYO (JP)

(72) Inventor: Daisuke KURASHINA, WAKO-SHI, SAITAMA-KEN (JP)

(21) Appl. No.: 16/323,346

(22) PCT Filed: Jun. 22, 2017
(86) PCT No.: PCT/JP2017/022948

§ 371 Date: Feb. 5, 2019

(30) Foreign Application Priority Data
Aug. 9, 2016 (JP) 2016-156410

(51) Int. Cl. C25B 9/04; C25B 1/02; H01M 8/0656; C25B 9/06

(52) U.S. Cl. CPC C25B 9/04; C25B 9/066; H01M 8/0656; C25B 1/02

(57) ABSTRACT

A hydrogen processing device is provided with an electrolyte film including a proton-conductive oxide, an anode electrode, and a cathode electrode, a mixed gas including water vapor and a hydrocarbon gas being supplied to an anode chamber and an electrical potential being applied to the electrolyte film, whereby hydrogen modified in the anode chamber is moved to a cathode chamber. The anode electrode includes a first catalyst layer having a purification function, and a second catalyst layer having a modification function.

### TECHNICAL FIELD

The present invention relates to a hydrogen processing device in which a proton conductive oxide is used.

### BACKGROUND ART

Conventionally, autothermal reforming (ATR), steam reforming (SR), a partial oxidation reforming reaction (POX), and the like are commonly used as methods for producing hydrogen by reforming natural gas. Since impurities (CO and the like) other than hydrogen are contained within the gas discharged from a reformer that reforms natural gas by these reforming methods, high purity hydrogen is refined and purified by further being passed through a transformer and a purifier. The hydrogen which is purified in this manner is used, for example, as a fuel gas for a fuel cell vehicle or the like. In general, precious metals such as platinum and the like are frequently used in catalysts that are utilized in reformers and transformers.

In the general method of hydrogen production as described above, large-scale hydrogen production is mainstream from the standpoint of improving thermal efficiency, and there is a problem in that the hydrogen production system is made high in cost due to the complexity of the reaction process and the large size and scale of the system. Further, in making the process smaller in scale, outflowing of impurities is more likely to occur in comparison with a large-scale purification process, and thus difficulties arise in the production of high purity hydrogen. Furthermore, precious metal catalysts are used in the reformer and the transformer, which leads to an increase in costs.

On the other hand, in Japanese Laid-Open Patent Publication No. 2005-048247, a device is disclosed for recovering hydrogen from methane gas and water vapor gas utilizing a proton selective permeation function of a proton conductor. More specifically, in such a device, a solid electrolyte is placed in an energized state, and a mixed gas in which the water vapor gas and the methane gas exist as a mixture is supplied to an anode electrode of the proton electrolysis cell, whereby protons that permeate through the solid electrolyte are recovered from a cathode electrode in the form of hydrogen gas.

### SUMMARY OF INVENTION

The present invention has been devised in relation to the above-described conventional technique, and has the object of providing a hydrogen processing device which is capable of producing hydrogen with higher efficiency.

In order to achieve the aforementioned object, the present invention is characterized by a hydrogen processing device, including an electrolyte membrane including a proton conductive oxide, an anode electrode disposed on one side of the electrolyte membrane, and a cathode electrode disposed on another side of the electrolyte membrane, wherein a mixed gas containing water vapor and a hydrocarbon gas is supplied to an anode chamber in which the anode electrode is disposed, and an electrical potential is applied to the electrolyte membrane, whereby hydrogen that is reformed in the anode chamber is moved into a cathode chamber in which the cathode electrode is disposed, and the anode electrode includes a first catalyst layer having a purification function, and a second catalyst layer having a reforming function.

According to the hydrogen processing device of the present invention in which the above-described configuration is adopted, by applying an electrical potential to the electrolyte membrane while carrying out reforming of the hydrocarbon gas on the side of the anode via the electrolyte membrane including the proton conductive oxide, since only hydrogen is moved from the side of the anode to the side of the cathode, it is possible for only hydrogen to be purified on the side of the cathode. Further, since only the hydrogen on the side of the anode is moved to the side of the cathode, the equilibrium of the reforming reaction on the side of the anode also undergoes movement or shifting, and the hydrogen production efficiency due to a non-equilibrium reaction is improved. Furthermore, since the anode electrode includes the two catalyst layers having different functions, it is possible to further promote the reactions (a reforming reaction and a shift reaction) that take place at the anode electrode. Thus, according to the present invention, hydrogen can be produced with higher efficiency.

The above-described hydrogen processing device may further include a power generation cell to which a fuel gas containing a hydrocarbon gas, and an oxygen-containing gas are supplied, and which is configured to generate electrical power electrochemically, wherein a processing stack may be constituted by stacking the power generation cell, and a hydrogen production cell including the electrolyte membrane, the anode electrode, and the cathode electrode.

In accordance with such a configuration, at the time that hydrogen is produced, exhaust heat during power generation in the power generation cell is supplied as heat that is required for the production of hydrogen in the hydrogen production cell. Therefore, it is unnecessary to supply heat from the exterior, and the hydrogen can be produced efficiently.

In the above-described hydrogen processing device, if there is a demand for hydrogen production, generated electrical power from the power generation cell may be supplied to the hydrogen production cell.

In accordance with such a configuration, it is possible to produce hydrogen with high efficiency using the generated electrical power of the power generation cell.

In the above-described hydrogen processing device, if there is not a demand for hydrogen production, generated electrical power from the power generation cell need not be supplied to the hydrogen production cell.

In accordance with such a configuration, the generated electrical power can be directly supplied to an external load.

According to the hydrogen processing device of the present invention, hydrogen can be produced with higher efficiency.

### BRIEF DESCRIPTION OF DRAWINGS

FIG. 1 is a schematic diagram of a hydrogen production system including a hydrogen processing device according to an embodiment of the present invention;

FIG. 2 is a schematic configuration diagram of the hydrogen processing device;

FIG. 3 is a diagram illustrating the principle of a hydrogen production process that takes place in the hydrogen processing device;

FIG. 4 is a graph showing a relationship between a current value applied to an electrolyte membrane and a total hydrogen concentration of an anode and a cathode; and

FIG. 5 is a graph showing a difference in a methane conversion rate between a case in which a second catalyst layer is present, and a case in which the second catalyst layer is not present.

### DESCRIPTION OF EMBODIMENTS

A preferred embodiment of a hydrogen processing device according to the present invention will be presented and described in detail below with reference to the accompanying drawings.

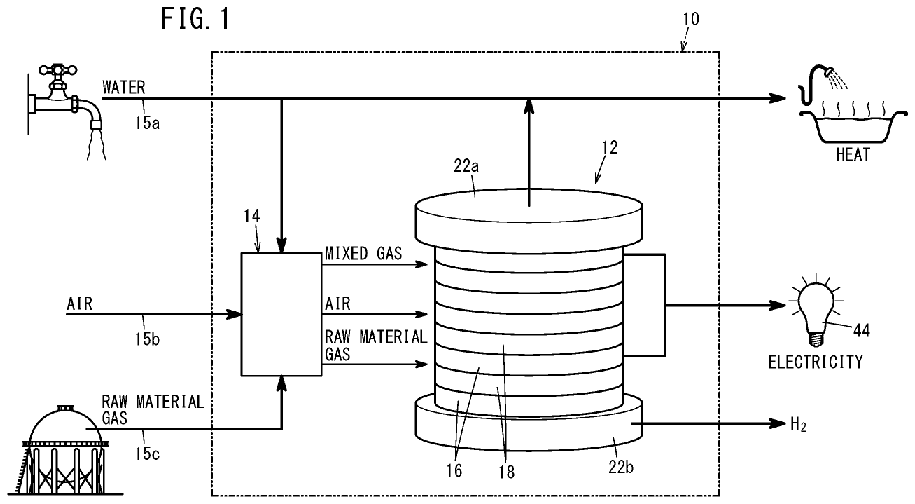

A hydrogen production system 10 shown in FIG. 1 comprises a hydrogen processing device 12 (processing stack) according to the present embodiment, and auxiliary equipment 14 attached to the hydrogen processing device 12. The hydrogen processing device 12 is equipped with a plurality of power generation cells 16 and a plurality of hydrogen production cells 18. The power generation cells 16 and the hydrogen production cells 18 are stacked in an alternating fashion.

The hydrogen processing device 12 receives the supply of a fuel gas and an oxygen-containing gas from the auxiliary equipment 14, and carries out generation of electrical power by an electrochemical reaction, together with receiving the supply of a mixed gas containing water vapor and methane gas from the auxiliary equipment 14 to thereby produce (purify) hydrogen. Heat that is generated by operation of the hydrogen processing device 12 is recovered as waste heat, and can be used for producing hot water, for example.

Water (tap water or the like) is supplied to the auxiliary equipment 14 via a water line 15a, air is supplied via an air line 15b, and a raw material gas (natural gas or the like) containing methane gas is supplied via a raw material gas line 15c. Moreover, the raw material gas that is supplied via the raw material gas line 15c may be a gas containing a hydrocarbon gas, or may be a biogas. Since it is possible to use not only methane gas but also a biogas, the present invention can contribute to a reduction in CO₂ emissions. The auxiliary equipment 14 is a peripheral device of the hydrogen processing device 12, and generates water vapor from the supplied water, and together therewith, mixes the water vapor and the raw material gas, and supplies the obtained mixed gas to the hydrogen processing device 12. Further, the auxiliary equipment 14 raises the temperature of the supplied air, and supplies it as an oxygen-containing gas to the hydrogen processing device 12.

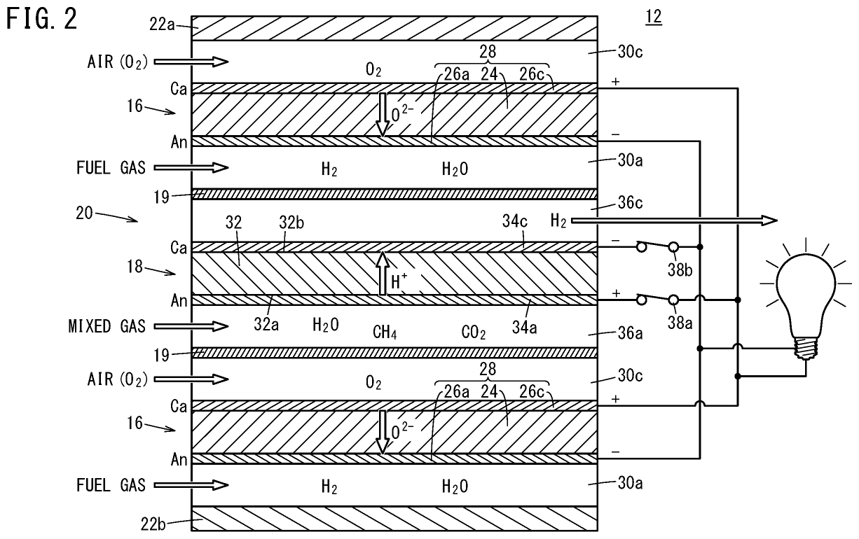

As shown in FIG. 2, in the hydrogen processing device 12, a plurality of the power generation cells 16 (unit fuel cells) and a plurality of the hydrogen production cells 18 are alternately stacked with separators 19 interposed therebetween to thereby make up a stacked body 20, together with end plates 22a and 22b being disposed at both ends in the stacking direction of the stacked body 20.

Each of the power generation cells 16 is configured as a solid oxide fuel cell (SOFC). More specifically, each of the power generation cells 16 is equipped with an electrolyte membrane 24 made of a solid electrolyte, an anode electrode 26a which is arranged (stacked) on one surface of the electrolyte membrane 24, and a cathode electrode 26c which is arranged (stacked) on another surface of the electrolyte membrane 24. A membrane electrode assembly 28 (MEA) is constituted by the electrolyte membrane 24, the anode electrode 26a, and the cathode electrode 26c.

The electrolyte membrane 24 is constituted by an oxide ion conductor made of, for example, stabilized zirconia, a ceria based material, a lanthanum gallate based material, or the like.

The anode electrode 26a is an electrode catalyst layer provided in an anode chamber 30a, which defines a fuel gas flow field through which the fuel gas flows. An inlet side of the anode chamber 30a communicates with a non-illustrated fuel gas supply passage, which is disposed to extend through the stacked body 20 in the stacking direction thereof, and the fuel gas is supplied from the fuel gas supply passage. An outlet side of the anode chamber 30a communicates with a non-illustrated fuel gas discharge passage, which is disposed to extend through the stacked body 20 in the stacking direction thereof, and the fuel gas is discharged from the fuel gas discharge passage. As the material of the anode electrode 26a, there may be selected a material that is generally adopted in a solid oxide fuel cell. Typical examples thereof include Ni-YSZ cermet and Ni-SSZ cermet. Alternatively, the material may be a cermet of Ni and yttrium-doped ceria (YDC), a cermet of Ni and samarium-doped ceria (SDC), a cermet of Ni and gadolinium-doped ceria (GDC), or the like.

The cathode electrode 26c is an electrode catalyst layer provided in a cathode chamber 30c, which defines an oxygen-containing gas flow field through which the oxygen-containing gas flows. An inlet side of the cathode chamber 30c communicates with a non-illustrated oxygen-containing gas supply passage, which is disposed to extend through the stacked body 20 in the stacking direction thereof, and the oxygen-containing gas is supplied from the oxygen-containing gas supply passage. An outlet side of the cathode chamber 30c communicates with a non-illustrated oxygen-containing gas discharge passage, which is disposed to extend through the stacked body 20 in the stacking direction thereof, and the oxygen-containing gas is discharged from the oxygen-containing gas discharge passage.

As the material of the cathode electrode 26c, there may be selected a material that is generally adopted in a solid oxide fuel cell. As representative examples thereof, there may be cited, specifically, any one selected from the group of a La—Sr—Co—O (LSC) based perovskite type oxide, a La—Sr—Co—Fe—O (LSCF) based perovskite type oxide, a La—Sr—Mn—O (LSM) based perovskite type oxide, and a Ba—Sr—Co—Fe—O (BSCF) based perovskite type oxide, or mixtures prepared by mixing with respect to such perovskite type oxides an oxide ion conductor including a ceria based oxide such as SDC, YDC, GDC, LDC or the like.

Amongst the plurality of power generation cells 16, the anode electrodes 26a thereof are electrically connected to each other. Further, amongst the plurality of power generation cells 16, the cathode electrodes 26c thereof are electrically connected to each other.

The hydrogen production cell 18 comprises an electrolyte membrane 32, an anode electrode 34a disposed on one side (one surface 32a) of the electrolyte membrane 32, and a cathode electrode 34c disposed on another side (another surface 32b) of the electrolyte membrane 32. The electrolyte membrane 32 is a solid electrolyte containing a proton conductive oxide, and is made of, for example, a ceramic material having a perovskite structure.

The anode electrode 34a is an electrode catalyst layer provided in an anode chamber 36a through which a mixed gas containing water vapor and methane gas flows. The anode electrode 34a can be electrically connected via a switching element 38a (conductor) to the cathode electrode 26c of the power generation cell 16. The cathode electrode 34c is an electrode catalyst layer provided in a cathode chamber 36c. The cathode electrode 34c can be electrically connected via a switching element 38b (conductor) to the anode electrode 26a of the power generation cell 16.

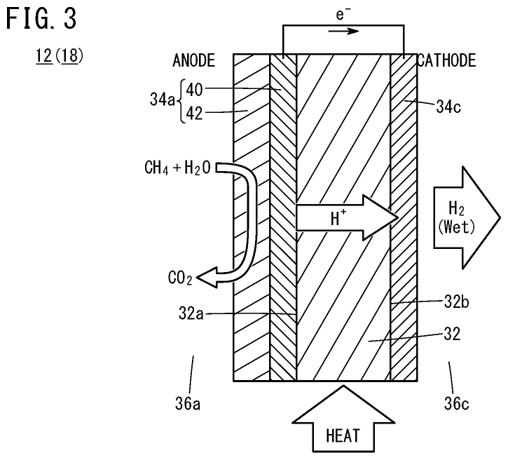

As shown in FIG. 3, the anode electrode 34a is made up from a first catalyst layer 40 (electrode layer) having a purification function (hydrogen purification function), and a second catalyst layer 42 (supporting catalyst layer) having a reforming function (steam reforming function). The first catalyst layer 40 purifies hydrogen by a shift reaction represented by the following expression (1). The second catalyst layer 42 reforms the mixed gas containing water vapor and methane gas by a reforming reaction represented by the following expression (2).

CO+H₂O→CO₂+H₂ (1)

CH₄+H₂O→CO+3H₂ (2)

The first catalyst layer 40 is formed on the one surface 32a of the electrolyte membrane 32. The second catalyst layer 42 is formed on a surface of the first catalyst layer 40 on an opposite side from the electrolyte membrane 32 (on the side of the anode chamber 36a). More specifically, the first catalyst layer 40 is formed between the electrolyte membrane 32 and the second catalyst layer 42.

The first catalyst layer 40 is constituted from a material containing, for example, Ni (nickel), Pt (platinum), Pd (palladium), Ag (silver), or the like. The first catalyst layer 40 is fabricated, for example, by a cermet method. In the case of such a cermet method, for example, the first catalyst layer 40 is formed by applying a paste containing Ni on one surface of the electrolyte membrane 32 by screen printing or the like, and the paste is subjected to baking. The first catalyst layer 40 may be a cermet or the like, in the same manner as the anode electrode 26a that constitutes the membrane electrode assembly 28 described above.

The second catalyst layer 42 performs a function to assist (support) the steam reforming reaction on the side of the anode. More specifically, even in the case that the second catalyst layer 42 is not provided, the reforming reaction occurs due to a reaction between the high temperature steam and the methane gas in the anode chamber 36a. However, due to the presence of the second catalyst layer 42, the reforming reaction is significantly promoted. The second catalyst layer 42 is constituted from a material containing, for example, Ni (nickel), Pt (platinum), Pd (palladium), Ag (silver), or the like.

The cathode electrode 34c is constituted from a material containing, for example, Ni (nickel), Pt (platinum), Pd (palladium), Ag (silver), or the like. The cathode electrode 34c is fabricated by, for example, a cermet method. In the case of such a cermet method, for example, the cathode electrode 34c is formed by applying a paste containing Ni on the other surface of the electrolyte membrane 32 by screen printing or the like, and the paste is subjected to baking. The first catalyst layer 40 may be a cermet or the like, in the same manner as the cathode electrode 26c that constitutes the membrane electrode assembly 28 described above.

Next, operations of the hydrogen processing device 12, which is configured in the manner described above, will be described.

In FIG. 1, water, air, and the raw material gas are supplied to the auxiliary equipment 14. The auxiliary equipment 14 generates water vapor from the supplied water, together with mixing water vapor and the raw material gas, and thereby obtains a mixed gas containing water vapor and methane gas, and supplies the mixed gas to the hydrogen processing device 12. Further, the auxiliary equipment 14 raises the temperature of the air and the raw material gas, and supplies them to the hydrogen processing device 12.

In the case that a demand for hydrogen production is made with respect to the hydrogen processing device 12, the hydrogen processing device 12 generates electrical power in the power generation cells 16, together with supplying the generated electrical power to the hydrogen production cells 18.

More specifically, in the power generation cells 16, as shown in FIG. 2, the fuel gas (raw material gas) is supplied to the anode chamber 30a, whereas the oxygen-containing gas (air) is supplied to the cathode chamber 30c. Consequently, in the membrane electrode assembly 28, the fuel gas is supplied to the anode electrode 26a and the oxygen-containing gas is supplied to the cathode electrode 26c.

Therefore, oxide ions (O²⁻) move from the cathode electrode 26c and through the electrolyte membrane 24 to the anode electrode 26a, and power generation is carried out by an electrochemical reaction. Further, in the power generation cells 16, heat is generated in association with the generation of electrical power. Moreover, the mixed gas of steam and the raw material gas may be supplied as a fuel gas to the anode chamber 30a. In this case, an internal reformation is promoted, in which methane in the raw material gas reacts with steam, and is decomposed into hydrogen and carbon monoxide.

On the other hand, in the hydrogen production cells 18, the mixed gas containing water vapor and methane gas is supplied to the anode chamber 36a. Further, in the hydrogen production cells 18, a voltage is applied to the electrolyte membrane 32 by the electrical power generated by the power generation cells 16, and heat generated accompanying the generation of power of the power generation cells 16 is supplied. Consequently, in the anode electrode 34a, hydrogen is generated by the reforming reaction and the shift reaction that were described above. In addition, the hydrogen generated on the side of the anode moves to the side of the cathode. The reaction temperature in the hydrogen production cells 18 is set from 600° C. to 800° C., for example. Although the reaction in the hydrogen production cells 18 is an endothermic reaction, the heat required for the reaction is covered by the exhaust heat generated in the power generation cells 16.

More specifically, as shown in FIG. 3, in the second catalyst layer 42, the reforming reaction of the above-described expression (2) takes place, whereupon the methane gas is steam reformed, and carbon monoxide (CO) and hydrogen (H₂) are generated. Further, in the first catalyst layer 40, the shift reaction of the above-described expression (1) takes place, whereupon carbon dioxide (CO₂) and hydrogen (H₂) are generated. In addition, protons (H⁺) and electrons (e) are generated from the hydrogen existing at the interface between the first catalyst layer 40 and the electrolyte membrane 32.

At this time, the two switching elements 38a and 38b (see FIG. 2) are controlled in a manner so as to be closed and placed in an energized state, and since the anode electrode 26a and the cathode electrode 26c are electrically connected to the power generation cell 16, a voltage is applied to the electrolyte membrane 24. Therefore, protons pass through the electrolyte membrane 24 and move from the anode electrode 26a to the cathode electrode 26c, and together therewith, electrons pass through the electrical circuit and move from the anode electrode 26a to the cathode electrode 26c.

Consequently, the protons and the electrons combine at the interface between the electrolyte membrane 24 and the cathode electrode 26c, and thereby generate hydrogen. Accordingly, at the cathode, it is possible for only moist hydrogen to be generated in the absence of impurities (CO, CO₂, etc.) which are generated by the reforming reaction. The hydrogen generated at the cathode is discharged to the exterior of the hydrogen processing device 12 and recovered, and is utilized for a predetermined purpose (for example, as a fuel gas for a fuel cell vehicle).

On the other hand, in the case that no demand is made for hydrogen production with respect to the hydrogen processing device 12, then as shown in FIG. 2, the hydrogen processing device 12 carries out generation of electrical power in the power generation cells 16, together with controlling the two switching elements 38a and 38b so as to open (to be placed in a non-energizing state).

Consequently, since the generated electrical power from the power generation cells 16 is not supplied to the hydrogen processing device 12, the generated electrical power can be supplied directly to an external load.

In this case, in accordance with the hydrogen processing device 12 according to the present embodiment, the mixed gas containing water vapor and methane gas is supplied to the anode chamber 36a in which the anode electrode 34a is disposed, and an electrical potential is applied to the electrolyte membrane 32, whereby hydrogen that is generated in the anode chamber 36a is moved into a cathode chamber 36c in which the cathode electrode 34c is disposed. In addition, the anode electrode 34a includes the first catalyst layer 40 having a purification function, and the second catalyst layer 42 having a reforming function.

Therefore, by applying a voltage to the electrolyte membrane 32 while reforming of the methane gas is carried out on the side of the anode via the electrolyte membrane 32 including the proton conductive oxide, only the hydrogen moves from the side of the anode to the side of the cathode. Thus, on the side of the cathode, it is possible for only the hydrogen, which contains no impurities generated in the reforming reaction, to be purified. Further, since only the hydrogen on the side of the anode is moved to the side of the cathode, the equilibrium of the reforming reaction on the side of the anode also undergoes movement or shifting, and the hydrogen production efficiency due to a non-equilibrium reaction is improved. More specifically, since the hydrogen generated on the side of the anode is separated on the side of the cathode, the shift reaction on the side of the anode is further promoted.

Furthermore, since the anode electrode 34a includes the two catalyst layers (the first catalyst layer 40 and the second catalyst layer 42) having different functions, it is possible to further promote the reactions (the reforming reaction and the shift reaction) that take place at the anode electrode 34a. Thus, according to the present invention, hydrogen can be produced with higher efficiency.

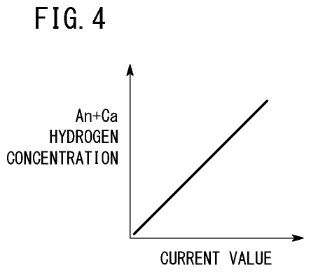

In this instance, a relationship between the current value applied to the electrolyte membrane 32, and the hydrogen concentration in the anode chamber 36a and the cathode chamber 36c is shown in FIG. 4. As shown in FIG. 4, the total hydrogen concentration in the anode chamber 36a and the cathode chamber 36c increases accompanying an increase in the current value applied to the hydrogen production cell 18. Therefore, it can be understood that, by merely applying the current to the electrolyte membrane 24, the amount of hydrogen in accordance with the current value increases in volume due to shifting of the equilibrium. Such a feature shows that, according to the present invention, hydrogen can be produced with high efficiency.

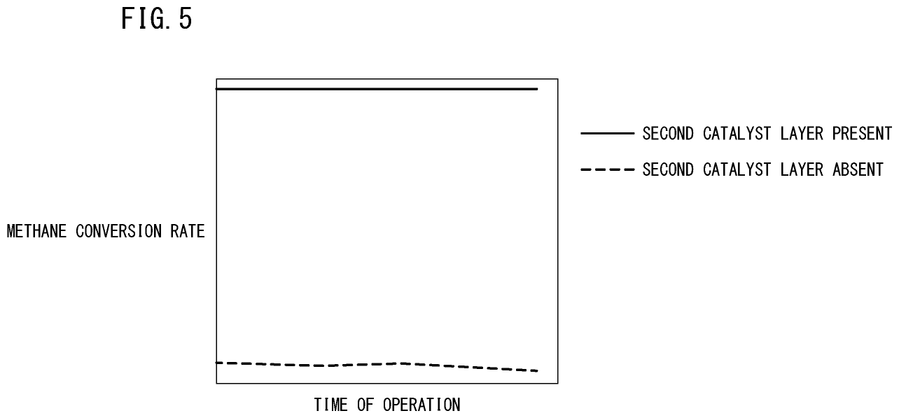

A test was conducted in order to confirm the effect of improving the methane conversion rate by the second catalyst layer 42. The results of this test are shown in FIG. 5. As shown in FIG. 5, in the case that the second catalyst layer 42 was provided, it was confirmed that the methane conversion rate was significantly improved in comparison with a case in which the second catalyst layer 42 was not provided. Therefore, according to the present invention, since not only the first catalyst layer 40 having the refining function but also the second catalyst layer 42 having the reforming function are provided on the anode electrode 34a, steam reforming at the anode electrode 34a is suitably promoted, and therefore, it is possible to produce hydrogen with high efficiency.

Further, according to the present embodiment, in the hydrogen processing device 12, the hydrogen production cells 18 and the power generation cells 16 are alternately stacked to thereby constitute a processing stack. In addition, at the time that the hydrogen is produced, exhaust heat during power generation in the power generation cells 16 is used and supplied as heat that is required for the production of hydrogen in the hydrogen production cell 18. Therefore, it is unnecessary to supply heat from the exterior, and the hydrogen can be produced efficiently. In addition, since a thermal balance can be achieved in the interior of the hydrogen processing device 12, a favorable resistance to heat can be obtained.

Furthermore, according to the present embodiment, when a demand for hydrogen production is made, the switching elements 38a and 38b are controlled in a manner so that the generated electrical power of the power generation cells 16 is supplied to the hydrogen production cells 18. Therefore, it is possible to produce hydrogen with high efficiency using the generated electrical power of the power generation cells 16. On the other hand, in the case that a demand for hydrogen production is not made, since the switching elements 38a and 38b are controlled in a manner so that the generated power of the power generation cells 16 is not supplied to the hydrogen production cells 18, it is possible to supply the generated electrical power directly to an external load 44. Accordingly, the hydrogen processing device 12 can be used as a fuel cell system.

The present invention is not limited to the embodiment described above, and various modifications may be made thereto within a range that does not deviate from the essence and gist of the present invention as set forth in the appended claims.

1. A hydrogen processing device, comprising:
an electrolyte membrane including a proton conductive oxide;
an anode electrode disposed on one side of the electrolyte membrane; and
a cathode electrode disposed on another side of the electrolyte membrane;
wherein a mixed gas containing water vapor and a hydrocarbon gas is supplied to an anode chamber in which the anode electrode is disposed, and an electrical potential is applied to the electrolyte membrane, whereby hydrogen that is reformed in the anode chamber is moved into a cathode chamber in which the cathode electrode is disposed; and
the anode electrode includes a first catalyst layer having a purification function, and a second catalyst layer having a reforming function.

2. The hydrogen processing device according to claim 1, further comprising:
a power generation cell to which a fuel gas containing a hydrocarbon gas, and an oxygen-containing gas are supplied, and which is configured to generate electrical power electrochemically;
wherein a processing stack is constituted by stacking the power generation cell, and a hydrogen production cell including the electrolyte membrane, the anode electrode, and the cathode electrode.

3. The hydrogen processing device according to claim 2, wherein, if there is a demand for hydrogen production, generated electrical power from the power generation cell is supplied to the hydrogen production cell.

4. The hydrogen processing device according to claim 2, wherein, if there is not a demand for hydrogen production, generated electrical power from the power generation cell is not supplied to the hydrogen production cell.

5. The hydrogen processing device according to claim 3, wherein, if there is not a demand for hydrogen production, generated electrical power from the power generation cell is not supplied to the hydrogen production cell.
